(19) United States
(12) Patent Application Publication
(10) Pub. No.: US 2024/0100975 A1
(43) Pub. Date: Mar. 28, 2024

(54) CONTACTOR FOR VEHICLE, VEHICLE CHARGING AND POWER DISTRIBUTION SYSTEM, CHARGING PILE, AND VEHICLE

(71) Applicant: BYD COMPANY LIMITED, SHENZHEN (CN)

(72) Inventors: Tuodi HUANG, Shenzhen (CN); Xuechao WANG, Shenzhen (CN); Lei SHI, Shenzhen (CN); Dengyan YAN, Shenzhen (CN); Qing LIU, Shenzhen (CN)

(21) Appl. No.: 18/526,201

(22) Filed: Dec. 1, 2023

Related U.S. Application Data
(63) Continuation of application No. PCT/CN2022/116147, filed on Aug. 31, 2022.

(30) Foreign Application Priority Data
Sep. 3, 2021 (CN) 202111032856.3

(51) Int. Cl. B60L 53/16

(52) U.S. Cl. CPC B60L 53/16

(57) ABSTRACT

A contactor for a vehicle, includes: a first wiring terminal, a second wiring terminal, a conducting bar, and a driving assembly. A first conduction section and a second conduction section of the conducting bar are connected to each other and are configured to rotate with respect to each other. The first conduction section is fixed on the first wiring terminal, and the second conduction section is electrically connected to or electrically disconnected from the second wiring terminal. The driving assembly is configured to drive the second conduction section to move toward or away from the second wiring terminal. The first wiring terminal and the second wiring terminal are disposed opposite to the conducting bar in a first direction, the driving assembly is disposed opposite to the conducting bar, or the first wiring terminal, or the second wiring terminal in a second direction different from the first direction.

### CROSS-REFERENCE TO RELATED APPLICATIONS

This application is a Continuation application of International Patent Application No. PCT/CN2022/116147, filed on Aug. 31, 2022, which is based on and claims priority to and benefits of Chinese Patent Application No. 202111032856.3, filed on Sep. 3, 2021. The entire content of all of the above-referenced applications is incorporated herein by reference.

### FIELD

The present disclosure relates to the technical field of contactors, and more particularly, to a contactor for a vehicle, a vehicle charging and power distribution system, a charging pile, and a vehicle.

### BACKGROUND

Contactors are applied widely as electric control members for controlling on/off of circuits. A contactor in a related technology includes an electromagnetic mechanism, a spring plate component, a fixed contact, and a moving contact arranged sequentially in a length direction. That is to say, the moving contact, a conducting bar, a driving assembly, and the like of the existing contactor are arranged sequentially in the length direction of the contactor. The overall structure is long, the space occupation is large, and the structural strength is low. The contactor has a high risk of fracture under the impact of vibration or the like, and has a short service life, and thus, cannot be used as an automotive-grade contactor.

### SUMMARY

The present disclosure resolves at least one of the technical problems existing in the related art. Therefore, the present disclosure provides a contactor. The contactor is a more proper structure, a more proper space occupation, a high structural stability, and a long service life.

The present disclosure further provides a vehicle charging and power distribution system having the foregoing contactor.

The present disclosure further provides a charging pile having the foregoing contactor.

The present disclosure further provides a vehicle having the foregoing contactor.

A contactor according to an embodiment of a first aspect of the present disclosure includes: a first wiring terminal, a second wiring terminal, a conducting bar, and a driving assembly. A first conduction section and a second conduction section of the conducting bar are connected to each other and are configured to rotate with respect to each other. The first conduction section is fixed on the first wiring terminal, and the second conduction section is electrically connected to or electrically disconnected from the second wiring terminal. The driving assembly is configured to drive the second conduction section to move toward or away from the second wiring terminal. The first wiring terminal and the second wiring terminal are disposed opposite to the conducting bar in a first direction. The driving assembly is disposed opposite to the conducting bar, or the first wiring terminal, or the second wiring terminal in a second direction different from the first direction. In some embodiments, the second direction is orthogonal to the first direction

In the contactor according to this embodiment of the present disclosure, the conducting bar is arranged/disposed opposite to the first wiring terminal and the second wiring terminal in the first direction, and the driving assembly is arranged opposite to the conducting bar in the second direction, so that the space occupation of the contactor can be improved, to make the overall length of the contactor smaller, and the overall structural strength of the contactor can be increased, to reduce a probability that the contactor is prone to fracture from the middle after being used and vibrated for a long time, thereby prolonging the service life of the contactor.

A vehicle charging and power distribution system according to a second aspect of the present disclosure includes: a positive contactor, a negative contactor, and a pre-charging circuit contactor, where one or more of the positive contactor, the negative contactor, and the pre-charging circuit contactor include the contactor according to any one of the foregoing examples.

A charging pile according to a third aspect of the present disclosure includes the foregoing contactor.

A vehicle according to a fourth aspect of the present disclosure includes the foregoing contactor.

Other aspects and advantages of the present disclosure will be given in the following description, some of which will become apparent from the following description or may be learned from practices of the present disclosure.

### BRIEF DESCRIPTION OF THE DRAWINGS

FIG. 1 is a schematic diagram of a contactor according to a first embodiment of the present disclosure;

FIG. 2 is a three-dimensional schematic diagram of a contactor in a first position according to a first embodiment of the present disclosure;

FIG. 3 is a top view of a contactor in a first position according to a first embodiment of the present disclosure;

FIG. 4 is a three-dimensional schematic diagram of a contactor in a second position according to a first embodiment of the present disclosure;

FIG. 5 is a top view of a contactor in a first position according to a second embodiment of the present disclosure;

FIG. 6 is a schematic diagram of a driving assembly of a contactor in a first position according to a first embodiment of the present disclosure;

FIG. 7 is a schematic diagram of a driving assembly of a contactor in a second position according to a first embodiment of the present disclosure;

FIG. 8 is a schematic diagram of a contactor according to a second embodiment of the present disclosure;

FIG. 9 is a schematic diagram of a driving assembly of a contactor according to a second embodiment of the present disclosure;

FIG. 10 is a schematic of a sectional view of a contactor according to an embodiment of the present disclosure;

FIG. 11 is a schematic diagram of a vehicle charging and power distribution system according to an embodiment of the present disclosure;

FIG. 12 is a schematic diagram of a vehicle according to an embodiment of the present disclosure;

FIG. 13 is a schematic diagram of an operating circuit of a sensor used for the present disclosure;

FIG. 14 is a schematic diagram of a charging pile according to an embodiment of the present disclosure;

FIG. 15 shows a switch of a structure according to an embodiment of the present disclosure; and

FIG. 16 shows a switch of another structure according to an embodiment of the present disclosure.

The reference numerals in the specification are as follow:
Vehicle 10000,
Charging and power distribution system 1000, Charging pile 2000,
Contactor 100, Positive contactor 100a, Negative contactor 100b, Pre-charging circuit contactor 100c,
First wiring terminal 10, Second wiring terminal 20,
Conducting bar 30, First conduction section 31, Second conduction section 32, Flexible connection piece 33, Arc-shaped groove 331,
Driving assembly 40, Driving coil 41, Switch 42, Driving platform 421, Connection bracket 422, Permanent magnet 423, First magnetic pole 4231, Second magnetic pole 4232, Third magnetic pole 4233, Fourth magnetic pole 4234, Clamping piece 424,
Housing 50, Low-voltage signal terminal 60, and Sensor 70.

### DETAILED DESCRIPTION

The following describes embodiments of the present disclosure in detail. Examples of the embodiments are shown in the accompanying drawings, and same or similar reference signs in all the accompanying drawings indicate same or similar components or components having same or similar functions. The embodiments described below with reference to the accompanying drawings are exemplary and used merely for explaining the present disclosure, and should not be construed as a limitation on the present disclosure.

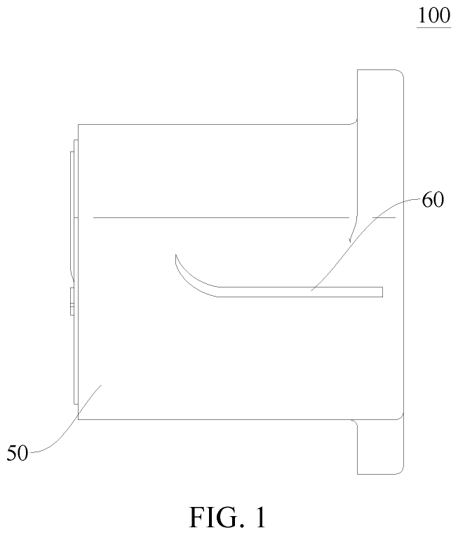

A contactor 100 according to an embodiment of the present disclosure will be described below with reference to FIG. 1 to FIG. 16.

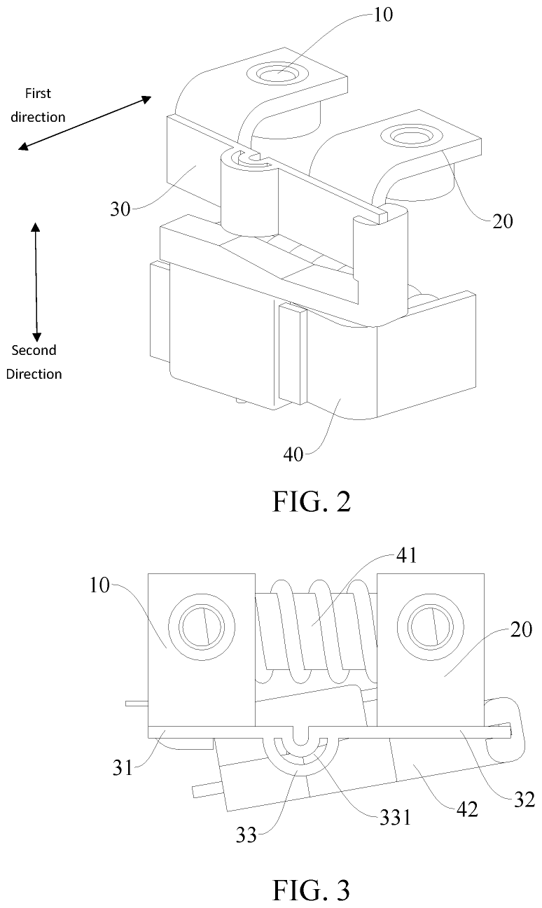

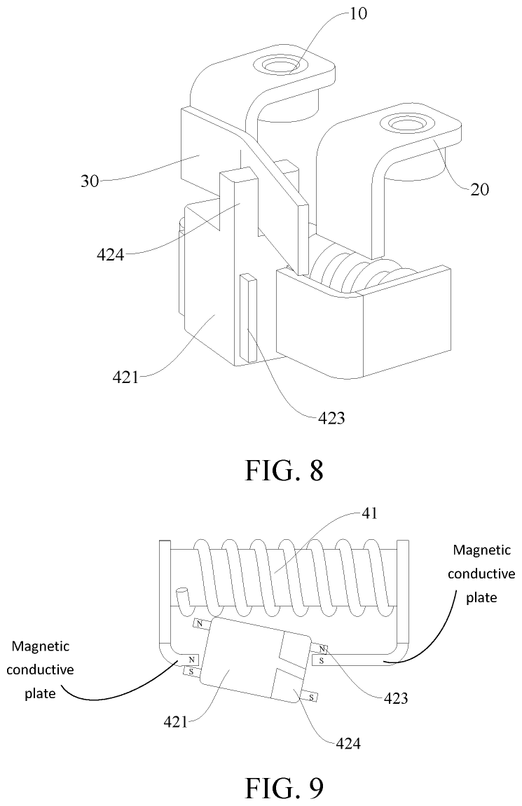

As shown in FIG. 2 to FIG. 5, and FIG. 8, the contactor 100 according to this embodiment of the present disclosure includes: a first wiring terminal 10, a second wiring terminal 20, a conducting bar 30, and a driving assembly 40.

The conducting bar 30 includes: a first conduction section 31 and a second conduction section 32, the first conduction section 31 and the second conduction section 32 being connected to each other and being rotatable with respect to each other, the first conduction section 31 being fixed on the first wiring terminal 10, and the second conduction section 32 being electrically connected to or electrically disconnected from the second wiring terminal 20; and the driving assembly 40 being configured to drive the second conduction section 32 to move toward or away from the second wiring terminal 20, where the first wiring terminal 10 and the second wiring terminal 20 are respectively arranged opposite to the conducting bar 30 in a first direction, at least one of the conducting bar 30, the second wiring terminal 20, and the first wiring terminal 10 is arranged opposite to the driving assembly 40 in a second direction, and the first direction different from the second direction, such that the first direction is orthogonal to the second direction.

The first wiring terminal 10 is electrically connected to or electrically disconnected from the second wiring terminal 20 through the conducting bar 30, and the driving assembly 40 is configured to drive the conducting bar 30 to move between a first position and a second position, to implement conduction and disconnection between the first wiring terminal 10 and the second wiring terminal 20. To be specific, the first position corresponds to a position in which the first wiring terminal 10 is conducted to the second wiring terminal 20, and the second position corresponds to a position in which the first wiring terminal 10 is disconnected from the second wiring terminal 20.

It should be noted that, that the first conduction section 31 and the second conduction section 32 are rotatable with respect to each other means that, the two conduction sections may rotate with respect to each other by connecting to a rotatable connection structure, or by connecting to a partially flexible structural member (that is, the conducting bar 30 is at least partially constructed as a flexible structure) and by bending the flexible structure member, or by connecting to an entirely flexible structural member (e.g., the entire conducting bar 30 is a flexible member) and by bending the flexible structural member. With the foregoing structure, when the second conduction section 32 is rotating, the bending wear of the conducting bar 30 is smaller, so that the service life of the conducting bar 30 can be prolonged, to increase the service life of the contactor 100.

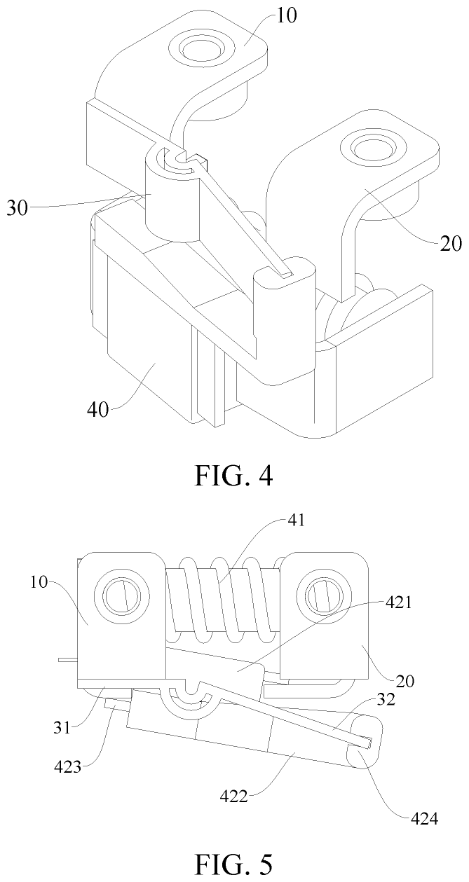

Then, referring to FIG. 2 and FIG. 4, the conducting bar 30 is arranged/disposed opposite to the first wiring terminal 10 and the second wiring terminal 20 in the first direction, and the conducting bar 30 is arranged opposite to the driving assembly 40 in the second direction. For example, the first direction corresponds to a length direction or width direction on a horizontal plane, and the second direction corresponds to a height direction. Therefore, the first wiring terminal 10, the second wiring terminal 20, and the conducting bar 30 are arranged at a same height, and the driving assembly 40 is located above or below the conducting bar 30, to reduce the size of the contactor 100 in the height direction.

In the contactor 100 according to this embodiment of the present disclosure, the conducting bar 30 is arranged opposite to the first wiring terminal 10 and the second wiring terminal 20 in the first direction, and the driving assembly 40 is arranged opposite to the conducting bar 30 in the second direction, so that the space occupation of the contactor 100 can be reduced, to make the overall length of the contactor 100 smaller, and the overall structural strength of the contactor 100 can be increased, to reduce a probability that the contactor 100 is prone to fracture from the middle after being used where the contactor is vibrated for a long time, such as a vehicle 10000, thereby prolonging the service life of the contactor 100.

In addition, through the foregoing arrangement, layered arrangement for the contactor 100 may be implemented. The high-voltage and low-voltage isolation may be implemented (an upper layer is a high-voltage conduction part, and a lower layer is a low-voltage control part), so that an arc-extinguishing manner is no longer limited to a form of collaboration between an inert gas and magnetic blowout arc-extinguishing, or may be implemented in a manner of overall wetting of an insulating liquid, or no arc-extinguishing structure is arranged. Based on diversified arc-extinguishing manners, it is unnecessary to perform insulating isolation on the driving assembly 40 and a chamber, which may resolve a low-voltage failure problem. In addition, it is unnecessary to inject an inert gas, and it is unnecessary to manufacture the contactor 100 with a ceramic and metal brazing technique, which may further simplify the manufacturing technique of the contactor 100 and reduce material manufacturing processes, and may reduce the manufacturing costs of the contactor 100 while increasing the production efficiency.

That the first wiring terminal 10 is fixed to the first conduction section 31 and the second wiring terminal 20 is electrically connected to the second conduction section 32 may also reduce the quantity of moving contacts, reduce a high-voltage power consumption problem caused by the moving contacts, reduce the arcing quantity, and reduce adhesion points, and may further reduce action wear generated when the contactor 100 performs circuit control, which are summarized as reducing risk points and power loss.

When the contactor 100 is operating, the second conduction section 32 impacts the second wiring terminal 20, to generate an operating noise. To reduce the operating noise of the contactor 100, the conducting bar 30 of the present disclosure may be constructed as a flexible member, and may be made of a flexible metal material (for example, a soft copper composite material or a soft silver composite material), to reduce the impacting noise and improve the use experience of the contactor 100. In addition, the use of the flexible metal material may increase the current, and may also reduce a contact resistance between the second wiring terminal 20 and the conducting bar 30, to reduce an adhesion probability of the two.

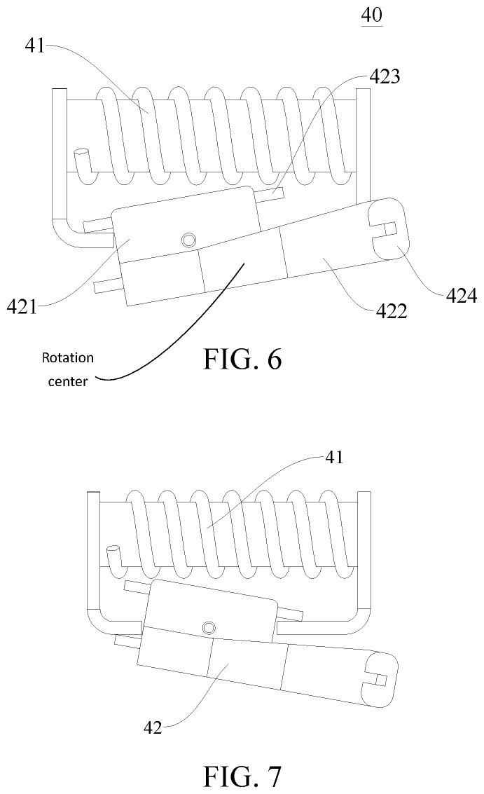

As shown in FIG. 6 and FIG. 7, according to some embodiments of the present disclosure, the driving assembly 40 includes: a switch 42 and a driving coil 41, the switch 42 is arranged opposite to the driving coil 41 in the first direction, the switch 42 is configured to swing with respect to an axis of the switch under action of a magnetic force of the driving coil 41, the switch is configured to drive the second conduction section 32 with a magnetic force to move toward or away from the second wiring terminal 20, the driving coil 41 is arranged opposite to the first wiring terminal 10 and the second wiring terminal 20 in the second direction, and the switch 42 is arranged opposite to the conducting bar 30 in the second direction.

The switch 42 is arranged opposite to the driving coil 41 in the first direction, the magnetic force generated by the driving coil 41 may drive the switch 42 to rotate with respect to the axis, the switch 42 is connected to and arranged opposite to the conducting bar 30 in the second direction to make it convenient to drive the conducting bar 30 to move, and the first wiring terminal 10 and the second wiring terminal 20 are both located above or below the driving coil 41, thereby facilitating high-voltage and low-voltage isolation of the low-voltage control part from the high-voltage conduction part.

As shown in FIG. 6 to FIG. 9, the switch 42 includes: a driving platform 421 and a connection bracket 422, an end (e.g., a first end) of the connection bracket 422 is connected to the driving platform 421, another end (e.g., a second end) of the connection bracket 422 is connected to the second conduction section 32, the driving platform 421 is configured to swing under action of a magnetic force of the driving coil 41, and the driving platform 421 is configured to drive the connection bracket 422 to swing and then drive the second conduction section 32 to move toward or away from the second wiring terminal 20.

That is to say, through collaboration between the driving platform 421 and the driving coil 41, the switch 42 rotates with respect to the axis, the connection bracket 422 is arranged above the driving platform 421, the connection bracket 422 and the driving platform 421 are integrally formed or are fixedly connected to each other, the driving platform 421 may rotate in synchronization with the connection bracket 422, and the connection bracket 422 is connected to the second conduction section 32, to drive the second conduction section 32 to swing with respect to the first conduction section 31, thereby improving movement smoothness of the conducting bar 30.

In some embodiments, a connection area between the first conduction section 31 and the second conduction section 32 is arranged opposite to the driving platform 421 in the second direction, so that swinging synchronism of the driving platform 421 and the first conduction section 31 is higher, which may increase control precision, and the arrangement of the contactor 100 is more compact, which may increase the integration level of the contactor 100.

In some embodiments, a connection area between the first conduction section 31 and the second conduction section 32 is arranged opposite to a rotation center of the switch 42 in the second direction, that is, a swinging center of the second conduction section 32 and a rotation center of the driving platform 421 (that is, the rotation center of the switch 42) are coaxial, thereby improving the movement synchronism of the two, the control precision, and the structural integration level.

In some embodiments, another end (e.g., the second end) of the connection bracket 422 is connected to an end (e.g., a first end) of the second conduction section 22 away from the first conduction section 21, or another end of the connection bracket 422 is connected to another end (e.g., a second end) of the second conduction section 22 close to the first conduction section 21.

That is to say, in some embodiments, the connection bracket 422 is connected to an end of the second conduction section 22 away from the first conduction section 21, to drive the second conduction section 22 to move toward or away from the second wiring terminal 20. In some embodiments, the connection bracket 422 is connected to an end of the second conduction section 22 close to the first conduction section 21, to drive the second conduction section 22 to move toward or away from the second wiring terminal 20.

In some embodiments, a clamping piece 424 is formed at another end of the connection bracket 422. In the first embodiment shown in FIG. 6 and FIG. 7, the clamping piece 424 clamps an end of the second conduction section 32 away from the first conduction section 31, to effectively increase the travel of the switch 42; or, in the second embodiment shown in FIG. 8 and FIG. 9, the clamping piece 424 clamps another end of the second conduction section 32 close to the first conduction section 31. Compared with the first embodiment, in the second embodiment, a smaller length between two ends of the connection bracket 422 may be set, so that the volume of the connection bracket 422 is smaller, thereby facilitating lightweight and compact arrangement of the contactor 100.

As shown in FIG. 6 and FIG. 7, a permanent magnet 423 is arranged on each of four corner areas of the driving platform 421, a magnetically conductive plate is arranged at each of two ends of the driving coil 41, the magnetically conductive plate (e.g., a first magnetically conductive plate) at an end of the driving coil 41 is configured to attract the two permanent magnets at the end of the driving platform 421, the magnetically conductive plate (e.g., a second magnetically conductive plate) at another end of the driving coil 41 is configured to attract the two permanent magnets at another end of the driving platform 421, and inner sides of the two permanent magnets 423 located at a same end of the driving platform 421 have opposite polarities.

It may be understood that, after the driving coil 41 is electrified, polarities of the magnetically conductive plates at the two ends are mutually different, and polarities of two permanent magnets 423 that are located at a side of the driving platform 421 corresponding to a same end of the driving coil 41 are mutually different, so that an end of the driving platform 421 may move toward the driving coil 41, and the other end of the driving platform 421 moves away from the driving coil 41.

The structure of the present disclosure is not limited thereto. In an embodiment, two permanent magnets 423 may be arranged at one end of the driving platform 421, or one permanent magnet 423 is arranged at each of two ends of the driving platform 421, so that the permanent magnets 423 are correspondingly located on corner areas, and then the switch 42 may be driven to rotate under action of a polar attraction or polar repulsion.

In this way, by arranging the permanent magnets 423, the contactor 100 may have the operating state maintained through magnetic attraction of the permanent magnets 423, that is, reside in the first position or the second position, and the driving coil 41 of the low-voltage control part does not need to be continuously electrified, to reduce the low-voltage loss and improve the energy consumption ratio of the contactor 100.

In the embodiment shown in FIG. 3, a distance between a free end of the permanent magnet 423 and a rotation center of the switch 42 is less than a distance between the rotation center of the switch 42 and a contact point that is between the second wiring terminal 20 and the second conduction section 32.

That is to say, a distance from an end of the permanent magnet 423 to the rotation center of the switch 42 is L1; and a distance between the rotation center of the switch 42 and a contact point that is between the second wiring terminal 20 and the second conduction section 32 is L2, and L1<L2. In this way, the movement travel of the second conduction section 22 is greater than the movement travel of the switch 42, and the travel of the switch 42 may be increased, to meet an electric clearance requirement of a high-voltage circuit to which the contactor 100 is connected.

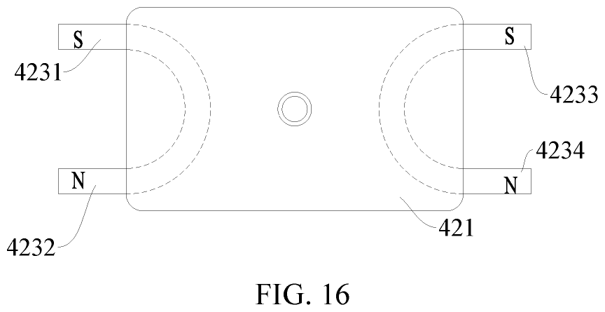

As shown in FIG. 9, FIG. 15, and FIG. 16, in an embodiment, the driving assembly 40 further includes a rotation shaft, and the driving platform 421 is connected to the rotation shaft and is configured to rotate with respect to the rotation shaft; the permanent magnet 423 includes a first magnetic pole 4231, a second magnetic pole 4232, a third magnetic pole 4233, and a fourth magnetic pole 4234, the first magnetic pole 4231 and the second magnetic pole 4232 have opposite polarities and are spaced apart at an end of the driving platform 421, an inner side of the first magnetic pole 4231 and an inner side of the second magnetic pole 4232 have opposite polarities, the third magnetic pole 4233 and the fourth magnetic pole 4234 are spaced apart at another end of the driving platform 421, an inner side of the third magnetic pole 4233 and an inner side of the second magnetic pole 4232 have opposite polarities, the inner side of the first magnetic pole 4231 and the inner side of the third magnetic pole 4233 have an identical polarity and are arranged close to the driving coil 41, and the inner side of the second magnetic pole 4232 and the inner side of the fourth magnetic pole 4234 have an identical polarity and are arranged away from the driving coil 41; and the magnetically conductive plate includes a first magnetically conductive plate and a second magnetically conductive plate, an end of the first magnetically conductive plate is connected to an end of the driving coil 41, another end of the first magnetically conductive plate is arranged between the first magnetic pole 4231 and the second magnetic pole 4232, an end of the second magnetically conductive plate is connected to another end of the driving coil 41, and another end of the second magnetically conductive plate is arranged between the third magnetic pole 4233 and the fourth magnetic pole 4234.

For example, the inner side of the first magnetic pole 4231 is the N polarity, the inner side of the second magnetic pole 4232 is the S polarity, the inner side of the third magnetic pole 4233 is the N polarity, the inner side of the fourth magnetic pole 4234 is the S polarity, the first magnetic pole 4231 and the second magnetic pole 4232 are arranged at a same end of the driving platform 421, and the third magnetic pole 4233 and the fourth magnetic pole 4234 are arranged at another end of the driving platform 421. When the driving coil 41 is electrified in a first current direction, the first magnetic pole 4231 is magnetically attracted to the first magnetically conductive plate, and the third magnetic pole 4233 is magnetically attracted to the second magnetically conductive plate. When the driving coil is electrified in a second current direction, the second magnetic pole 4232 is magnetically attracted to the first magnetically conductive plate, and the fourth magnetic pole 4234 is magnetically attracted to the second magnetically conductive plate. The first current direction and the second current direction are opposite to each other.

It may be understood that, the inner sides of the first magnetic pole 4231 and the third magnetic pole 4233 refer to opposite sides of the first magnetic pole 4231 and the third magnetic pole 4233; and the inner sides of the second magnetic pole 4232 and the fourth magnetic pole 4234 refer to opposite sides of the second magnetic pole 4232 and the fourth magnetic pole 4234. In the embodiment shown in FIG. 15, the permanent magnet 423 is constructed as a plate-shaped magnet, whose polarity is distributed as above. In the embodiment shown in FIG. 16, the permanent magnet 423 is constructed as a U-shaped magnet, and opening ends are two magnetic poles, whose polarities are distributed as above.

the driving platform 421 is constructed with insulating materials as an insulating member or the driving platform 421 is coated with an insulating layer. In this way, the second conduction section 32 is arranged on the connection bracket 422, and correspondingly the driving platform 421 is an insulating member or coated with an insulating layer, which may improve the high-voltage and low-voltage isolation effect between the high-voltage conduction part and the low-voltage control part, prevent high-voltage breakdown from causing the low-voltage failure, and improve the operating stability of the contactor 100.

As shown in FIG. 3 and FIG. 5, according to some embodiments of the present disclosure, the conducting bar 30 further includes: a flexible connection piece 33, the flexible connection piece 33 connects the first conduction section 31 to the second conduction section 32 and is located between the first conduction section 31 and the second conduction section 32, and the second conduction section 32 is configured to swing with respect to the flexible connection piece 33 to move toward or away from the second wiring terminal 20.

Two ends of the flexible connection piece 33 are separately connected to the first conduction section 31 and the second conduction section 32, the flexible connection piece 33 may be bent to enable the second conduction section 32 to move toward or away from the second wiring terminal 20, thereby improving convenience of switching of the contactor 100 between the first position and the second position. In addition, the arrangement of the flexible connection piece 33 may reduce the bending wear of the conducting bar 30, to prolong the service life of the conducting bar 30, and further increase the service life of the contactor 100.

The flexible connection piece 33 includes an arc-shaped groove 331, and the arc-shaped groove 331 runs through the flexible connection piece 33 in a height direction of the conducting bar 30. In this way, by setting a clearance, when the flexible connection piece 33 is bent, some bending deformation may be absorbed through deformation of the arc-shaped groove 331, to reduce the bending wear of the flexible connection piece 33, to effectively increase the service life of the conducting bar 30.

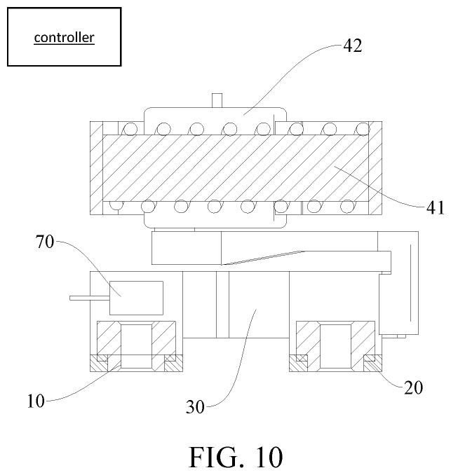

As shown in FIG. 10, in some embodiments, the contactor 100 further includes: a sensor 70, the sensor 70 being arranged close to the first wiring terminal 10 or the second wiring terminal 20 or the conducting bar 30 and configured to detect a circuit signal of the first wiring terminal 10 or the second wiring terminal 20 or the conducting bar 30 in real time; and a controller, the controller being electrically connected to the sensor 70 and configured to control the driving assembly 40 according to the circuit signal to connect or disconnect the contactor 100.

In this way, by arranging the controller and the sensor 70, as the first wiring terminal 10 is conducted to the second wiring terminal 20 through the conducting bar 30, a high-voltage loop has both the current and the heat changed, and correspondingly has the temperature changed, and the sensor 70 may obtain change information (temperature change, voltage change, current change, and the like) of the high-voltage loop during operating, and transmit the change information to the controller in the form of a circuit signal. The controller determines, according to the circuit signal, whether a cutoff threshold (a temperature threshold, a voltage threshold, or a current threshold) of the high-voltage loop is reached, and controls, when it is necessary to interrupt the high-voltage loop, the driving assembly 40 to interrupt the electric connection between the conduction section 32 and the second wiring terminal 20. It is unnecessary to arrange a fuse, to reduce high-voltage loss and reduce costs. In addition, after the contactor 100 is controlled and interrupted, even when electric equipment for which the contactor 100 of the present disclosure is used needs to continue operating, it may be ensured that a high voltage may be applied to the electric equipment and safety may be improved.

As shown in FIG. 13, a principle of conversion between a thermosensitive resistance and its corresponding voltage is: V=(NTC/(NTC+R))×VCC, where V is an input voltage, VCC is a standard voltage, R is a fixed resistance, and NTC is a thermosensitive resistance. Therefore, a manner of calculating a circuit signal AD is: AD=(V/VCC)×2n=(NTC/(NTC+R))×2n.

In this way, by obtaining a voltage value for a thermosensitive resistance, a required circuit signal may be obtained through conversion.

It should be noted that, after the fuse blows, the high-voltage circuit is thoroughly interrupted. However, in the present disclosure, by arranging the controller and the sensor 70, even if the high-voltage current needs to be interrupted based on the information obtained by the sensor 70, the high-voltage current may still be applied to increase safety under a maximum condition. For example, the contactor 100 of the present disclosure is applied to an electric vehicle 10000. When circuit information indicates that it is necessary to interrupt the contactor 100 but the vehicle 10000 is in a dangerous situation and needs to maintain an operating condition, a state of applying the high-voltage current may be maintained, and the electric connection between the conduction section 32 and the second wiring terminal 20 is interrupted after the vehicle travels to a safe position or is released from the dangerous situation.

The controller is configured to obtain a temperature or a voltage or a current of the first wiring terminal 10, or of the second wiring terminal 20, or of the conducting bar 30 according to the circuit signal; and

the controller is configured to electrically disconnect the second conduction section 32 and the second wiring terminal 20 when the first wiring terminal 10 or the second wiring terminal 20 or the conducting bar 30 has the temperature greater than a first temperature threshold, and/or the voltage greater than a first voltage threshold, and/or the current greater than a first current threshold.

The controller is further configured to electrically connect the second conduction section 32 and the second wiring terminal 20 when the first wiring terminal 10 or the second wiring terminal 20 or the conducting bar 30 has the temperature less than a second temperature threshold, and/or the voltage less than a second voltage threshold, and/or the current less than a second current threshold, where the second temperature threshold is less than or equal to the first temperature threshold, the second voltage threshold is less than or equal to the first voltage threshold, and the second current threshold is less than or equal to the first current threshold.

That is to say, in the contactor 100 of the present disclosure, by arranging the sensor and the controller, when the high-voltage circuit to which the contactor 100 is connected has the voltage exceeding the set first voltage threshold, the current exceeding the set first current threshold, or the temperature exceeding the set first temperature threshold, the contactor 100 may be interrupted, to improve use safety of the contactor 100 and reduce potential safety hazards of the high-voltage circuit, and the contactor 100 may be prevented from burning out.

Then, when the high-voltage circuit to which the contactor 100 is connected has the voltage reduced to be less than the set second voltage threshold, the current reduced to be less than the set first current threshold, or the temperature reduced to be less than the set first temperature threshold, the contactor 100 may be controlled to close again, so that the high-voltage circuit to which the contactor 100 is connected may be switched to the operating state in time, which may effectively improve the use safety and reduce the property loss.

As shown in FIG. 1, according to some embodiments of the present disclosure, the contactor further includes: a housing 50, the housing 50 including an accommodating space, the conducting bar 30, the first wiring terminal 10, the second wiring terminal 20, and the driving assembly 40 being all arranged in the accommodating space, and the first wiring terminal 10 and the second wiring terminal 20 at least partially protruding from the housing 50. In this way, the arrangement of the housing 50 may isolate the driving assembly 40 from the external environment, and may reduce interference from the external environment to the driving coil 41 and the switch 42 and increase control response efficiency of the low-voltage control part while increasing the operating stability.

A low-voltage signal terminal 60 is further arranged outside the housing 50, and the low-voltage signal terminal 60 is arranged on the housing 50 in a pluggable manner and is connected to the driving coil 41. In some embodiments, the housing 50 is provided with a bundle leading-out opening, and the low-voltage signal terminal 60 is led out of the housing through the bundle leading-out opening. In some embodiments, the low-voltage signal terminal 60 is fixed on the housing 50 in a pluggable form, the housing 50 is correspondingly provided with a plugging opening, and a metal wire is led into the housing 50 from the plugging opening and is electrically connected to the driving coil 41, so that the appearance of the contactor 100 of the present disclosure is maintained in consistency with that of a conventional contactor, to facilitate structural design and material switching, and the research and development cycle and the development costs may be reduced.

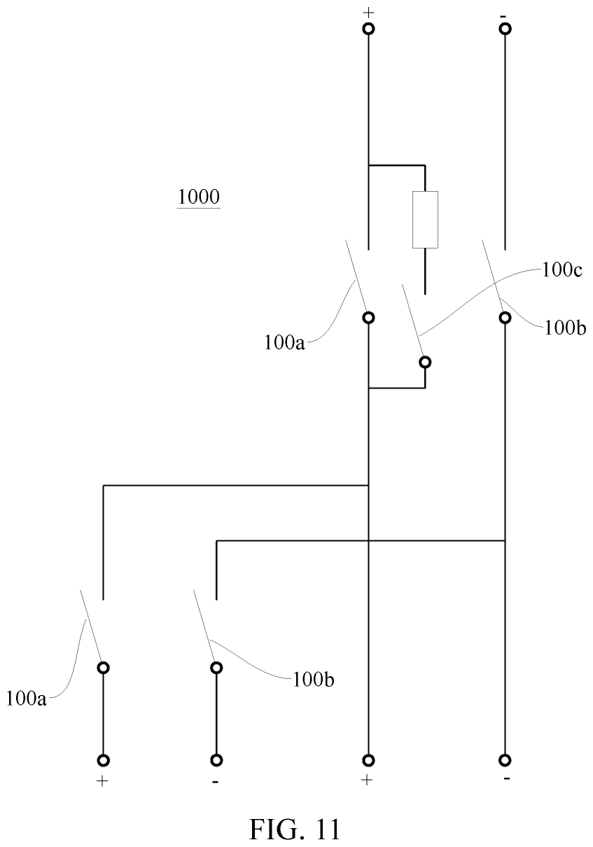

As shown in FIG. 11, a vehicle charging and power distribution system 1000 according to an embodiment of a second aspect of the present disclosure includes: a positive contactor 100a, a negative contactor 100b, and a pre-charging circuit contactor 100c, one or more of the positive contactor 100a, the negative contactor 100b, and the pre-charging circuit contactor 100c being constructed as the contactor 100 in the foregoing embodiments.

The vehicle charging and power distribution system 1000 includes: a battery end interface, an electric control end interface, and a direct-current charging interface. A charging loop is formed between the direct-current charging interface and the battery end interface, and a power distribution loop is formed between the electric control end interface and the battery end interface, and configured to provide electric energy for a vehicle. A positive contactor 100a is arranged on each of a positive side of the direct-current charging interface and a positive side of the battery end interface. A negative contactor 100b is arranged on each of a negative side of the direct-current charging interface and a negative side of the battery end interface. A pre-charging circuit is further arranged on the positive side of the battery end interface, and a pre-charging circuit contactor 100c connected in series to a pre-charging resistor and connected in parallel to the positive contactor 100a is arranged on the pre-charging circuit.

The foregoing contactor 100 is used for the vehicle charging and power distribution system 1000 according to this embodiment of the present disclosure, which may improve the operating stability and the use safety of the vehicle charging and power distribution system 1000, and prolong the service life.

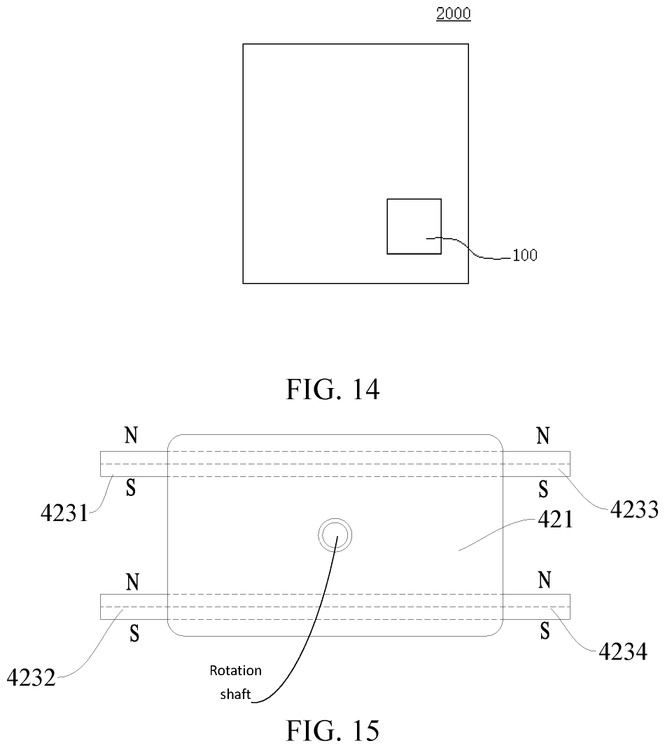

As shown in FIG. 14, the contactor 100 in the foregoing embodiments is used for a charging pile 2000 according to an embodiment of a third aspect of the present disclosure.

The foregoing contactor 100 in the foregoing embodiments is used for the charging pile 2000 according to this embodiment of the present disclosure, which may improve the use safety of the charging pile 2000.

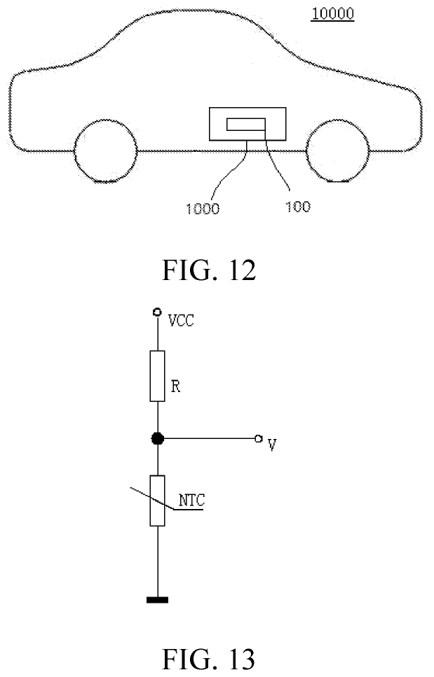

As shown in FIG. 12, the contactor 100 in the foregoing embodiments is used for a vehicle 10000 according to an embodiment of a third aspect of the present disclosure.

The foregoing contactor 100 in the foregoing embodiments is used for the vehicle 10000 according to this embodiment of the present disclosure, and on-board electric equipment performs electric connection and control through the contactor 100, which may increase the use safety of the vehicle 10000.

In the description of this specification, the description of the reference terms such as “an embodiment”, “some embodiments”, “exemplary embodiments”, “example”, “specific example”, or “some examples” means that the features, structures, materials or characteristics described with reference to the embodiment or example are included in at least one embodiment or example of the present disclosure. In this specification, schematic descriptions of the foregoing terms do not necessarily refer to the same embodiment or example. Moreover, the features, structures, materials, or characteristics described may be combined in any one or more embodiments or examples in an appropriate manner.

Although the embodiments of the present disclosure have been shown and described, a person of ordinary skill in the art should understand that various changes, modifications, replacements and variations may be made to the embodiments without departing from the principles and spirit of the present disclosure, and the scope of the present disclosure is as defined by the appended claims and their equivalents.

What is claimed is:

1. A contactor for a vehicle, comprising:
a first wiring terminal;
a second wiring terminal;
a conducting bar, the conducting bar comprising a first conduction section and a second conduction section, the first conduction section and the second conduction section being connected to each other and being configured to rotate with respect to each other, the first conduction section being fixed on the first wiring terminal, and the second conduction section being electrically connected to or electrically disconnected from the second wiring terminal; and
a driving assembly, the driving assembly being configured to drive the second conduction section to move toward or away from the second wiring terminal, wherein:
the first wiring terminal and the second wiring terminal are disposed opposite to the conducting bar in a first direction, at least one of the conducting bar, the first wiring terminal, and the second wiring terminal is disposed opposite to the driving assembly in a second direction different from the first direction.

2. The contactor according to claim 1, wherein the driving assembly comprises a switch and a driving coil, the switch is disposed opposite to the driving coil in the first direction, the switch is configured to swing with respect to an axis of the switch under a magnetic force of the driving coil, the switch is configured to drive the second conduction section to move toward or away from the second wiring terminal, the driving coil is disposed opposite to the first wiring terminal and the second wiring terminal in the second direction, and the switch is disposed opposite to the conducting bar in the second direction.

3. The contactor according to claim 2, wherein the switch comprises a driving platform and a connection bracket, a first end of the connection bracket is connected to the driving platform, a second end of the connection bracket is connected to the second conduction section, the driving platform is configured to swing under the magnetic force of the driving coil, and the driving platform is configured to drive the connection bracket to swing and to drive the second conduction section to move toward or away from the second wiring terminal.

4. The contactor according to claim 3, wherein a connection area between the first conduction section and the second conduction section is disposed opposite to the driving platform in the second direction.

5. The contactor according to claim 4, wherein the second end of the connection bracket is connected to a first end of the second conduction section away from the first conduction section, or the second end of the connection bracket is connected to a second end of the second conduction section close to the first conduction section.

6. The contactor according to claim 4, further comprising:
a clamping piece disposed at the second end of the connection bracket,
wherein the clamping piece clamps a first end of the second conduction section away from the first conduction section, or the clamping piece clamps a second end of the second conduction section close to the first conduction section.

7. The contactor according to claim 4, further comprising:
a permanent magnet disposed on each of four corner areas of the driving platform;
a first magnetically conductive plate disposed at a first end of the driving coil, wherein the first magnetically conductive plate is configured to attract two permanent magnets at a first end of the driving platform;
a second magnetically conductive plate disposed at a second end of the driving coil, wherein the second magnetically conductive plate is configured to attract two permanent magnets at a second end of the driving platform, and inner sides of the two permanent magnets located at a same end of the driving platform have opposite polarities.

8. The contactor according to claim 7, wherein a distance between a free end of the permanent magnet and a rotation center of the switch is less than a distance between the rotation center of the switch and a contact point that is between the second wiring terminal and the second conduction section.

9. The contactor according to claim 7, wherein the driving assembly further comprises a rotation shaft, and the driving platform is connected to the rotation shaft and is configured to rotate with respect to the rotation shaft;
the permanent magnet comprises a first magnetic pole, a second magnetic pole, a third magnetic pole, and a fourth magnetic pole; the first magnetic pole and the second magnetic pole are spaced apart at the first end of the driving platform, an inner side of the first magnetic pole and an inner side of the second magnetic pole have opposite polarities; the third magnetic pole and the fourth magnetic pole are spaced apart at the second end of the driving platform, an inner side of the third magnetic pole and an inner side of the second magnetic pole have opposite polarities; the inner side of the first magnetic pole and the inner side of the third magnetic pole have an identical polarity, and the inner side of the second magnetic pole and the inner side of the fourth magnetic pole have an identical polarity; and
a first end of the first magnetically conductive plate is connected to the first end of the driving coil, a second end of the first magnetically conductive plate is disposed between the first magnetic pole and the second magnetic pole; and a first end of the second magnetically conductive plate is connected to the second end of the driving coil, and a second end of the second magnetically conductive plate is disposed between the third magnetic pole and the fourth magnetic pole.

10. The contactor according to claim 7, wherein the driving platform comprises an insulation material, or the driving platform is coated with an insulation layer.

11. The contactor according to claim 1, wherein the conducting bar further comprises: a flexible connection piece, the flexible connection piece connects the first conduction section to the second conduction section and is located between the first conduction section and the second conduction section, and the second conduction section is configured to swing with respect to the flexible connection piece to move toward or away from the second wiring terminal.

12. The contactor according to claim 11, wherein the flexible connection piece comprises an arc-shaped groove, and the arc-shaped groove runs through the flexible connection piece in a height direction of the conducting bar.

13. The contactor according to claim 1, further comprising: a sensor disposed close to the first wiring terminal or the second wiring terminal or the conducting bar and configured to detect a circuit signal of the first wiring terminal or the second wiring terminal or the conducting bar in real time; and
a controller electrically connected to the sensor and configured to control the driving assembly according to the circuit signal to electrically connect or disconnect the second conduction section and the second wiring terminal.

14. The contactor according to claim 13, wherein the controller is configured to obtain a temperature or a voltage or a current of the first wiring terminal, or of the second wiring terminal, or of the conducting bar according to the circuit signal; and
the controller is configured to electrically disconnect the second conduction section and the second wiring terminal when the first wiring terminal or the second wiring terminal or the conducting bar has the temperature greater than a first temperature threshold, or the voltage greater than a first voltage threshold, or the current greater than a first current threshold.

15. The contactor according to claim 14, wherein the controller is configured to electrically connect the second conduction section and the second wiring terminal when the first wiring terminal or the second wiring terminal or the conducting bar has the temperature less than a second temperature threshold, or the voltage less than a second voltage threshold, or the current less than a second current threshold, wherein the second temperature threshold is less than or equal to the first temperature threshold, the second voltage threshold is less than or equal to the first voltage threshold, and the second current threshold is less than or equal to the first current threshold.

16. The contactor according to claim 2, further comprising: a housing comprising an accommodating space,
the conducting bar, the first wiring terminal, the second wiring terminal, and the driving assembly disposed in the accommodating space, and the first wiring terminal and the second wiring terminal at least partially protruding from the housing.

17. The contactor according to claim 16, further comprising a low-voltage signal terminal disposed outside the housing and connected to the driving coil.

18. A vehicle charging and power distribution system, comprising a positive contactor, a negative contactor, and a pre-charging circuit contactor, wherein one or more of the positive contactor, the negative contactor, and the pre-charging circuit contactor comprise a contactor, wherein the contactor comprises:
a first wiring terminal;
a second wiring terminal;
a conducting bar, the conducting bar comprising a first conduction section and a second conduction section, the first conduction section and the second conduction section being connected to each other and being configured to rotate with respect to each other, the first conduction section being fixed on the first wiring terminal, and the second conduction section being electrically connected to or electrically disconnected from the second wiring terminal; and
a driving assembly, the driving assembly being configured to drive the second conduction section to move toward or away from the second wiring terminal, wherein
the first wiring terminal and the second wiring terminal are disposed opposite to the conducting bar in a first direction, at least one of the conducting bar, the first wiring terminal, and the second wiring terminal is disposed opposite to the driving assembly in a second direction different from the first direction.

19. A charging pile, comprising a contactor, wherein the contactor comprises:
a first wiring terminal;
a second wiring terminal;
a conducting bar, the conducting bar comprising a first conduction section and a second conduction section, the first conduction section and the second conduction section being connected to each other and being configured to rotate with respect to each other, the first conduction section being fixed on the first wiring terminal, and the second conduction section being electrically connected to or electrically disconnected from the second wiring terminal; and
a driving assembly, the driving assembly being configured to drive the second conduction section to move toward or away from the second wiring terminal, wherein
the first wiring terminal and the second wiring terminal are disposed opposite to the conducting bar in a first direction, at least one of the conducting bar, the first wiring terminal, and the second wiring terminal is disposed opposite to the driving assembly in a second direction different from the first direction.

20. A vehicle, comprising the contactor according to claim 1.
